(19) United States
(12) Patent Application Publication
(10) Pub. No.: US 2004/0252618 A1
(43) Pub. Date: Dec. 16, 2004

(54) Multi-dimensional coding on quasi-close packed lattices

(76) Inventors: Willem Marie Julia Marcel Coene, Eindhoven (NL); Willem Gerard Ophey, Eindhoven (NL)

Correspondence Address: Corporate Patent Counsel, Philips Electronics North America Corporation, P O Box 3001, Briarcliff Manor, NY, 10510, US

(21) Appl. No.: 10/492,378

(22) PCT Filed: Oct. 14, 2002
(86) PCT No.: PCT/IB02/04250

(30) Foreign Application Priority Data
Oct. 15, 2001 (EP) 01203878.2

(51) Int. Cl. G11B 3/00; G11B 20/10; G11B 5/09

(52) U.S. Cl. 369/59.24

(57) ABSTRACT

The present invention relates to a method and system for multi-dimensionally coding and/or decoding an information to/from a lattice structure representing bit positions of said coded information in at least two dimensions. Encoding and/or decoding is performed by using a close-packed lattice structure, preferably a quasi-hexagonal lattice structure. In particular, at least partial quasi-hexagonal clusters consisting of one central bit and a plurality of nearest neighboring bits can be defined, and a code constraint can be applied such that for each of said at least partial quasi-hexagonal clusters a predetermined minimum number of said nearest neighboring bits are of the same bit state as said central bit. Thereby, intersymbol interferences can be minimized at a high code efficiency. Furthermore, another code constraint can be applied such that for each of said at least partial quasi-hexagonal clusters a predetermined minimum number of said nearest neighboring bits are of the opposite bit state as said central bit. This constraint provides an advantageous high pass characteristic to avoid large areas of channel bits of the same type.

The present invention relates to a method and system for performing a multi-dimensional coding.

With its omnipresent computers, all connected via the Internet, the Information Age has led to an explosion of information available to users. The decreasing cost of storing data, and the increasing storage capacities of the same small device footprint, have been key enablers of this revolution. While current storage needs are being met, storage technologies must continue to improve in order to keep pace with the rapidly increasing demand.

However, both magnetic and conventional optical data storage technologies, where individual bits are stored as distinct magnetic or optical changes on the surface of a recording medium, are approaching physical limits beyond which individual bits may be too small or too difficult to store. Storing information throughout the volume of a medium—not just on its surface—offers an intriguing high-capacity alternative.

Holographic data storage is a volumetric approach which, although conceived decades ago, has made recent progress toward practicality with the appearance of lower-cost enabling technologies, significant results from longstanding research efforts, and progress in holographic recording materials. In holographic data storage, an entire page of information is stored at once as an optical interference pattern within a thick, photosensitive optical material. This is done by intersecting two coherent laser beams within the storage material. The first, called the object beam, contains the information to be stored; the second, called the reference beam, is designed to be simple to reproduce—for example, a simple collimated beam with a planar wavefront. The resulting optical interference pattern causes chemical and/or physical changes in the photosensitive medium. A replica of the interference pattern is stored as a change in the absorption, refractive index, or thickness of the photosensitive medium. When the stored interference grating is illuminated with one of the two waves that was used during recording, some of this incident light is diffracted by the stored grating in such a fashion that the other wave is reconstructed. Illuminating the stored grating with the reference wave reconstructs the object wave, and vice versa.

As another three-dimensional or volumetric approach, the concept of multi-layer, fluorescent cards/discs (FMD/C) is a unique breakthrough, solving the problems of signal degradation associated with current reflective optical disc technologies of CD (Compact Disk) and DVD (Digital Versatile Disk). As with a CD or DVD, data on the FMD layers is encoded on a substrate in a series of geometrical features or volumetric marks. Each layer can have a capacity of 4.7 Gigabytes (as in the case of DVD). With FMD/C technology, each storage layer is coated with a transparent fluorescent material rather than the reflective metallic layer of a CD or DVD. When the laser beam hits a mark on a layer, fluorescent light is emitted. This emitted light has a different wavelength from the incident laser light—slightly shifted towards the red end of the light spectrum—and is incoherent in nature, in contrast to the reflected coherent light in current optical devices. The emitted light is not affected by data marks, and therefore transverses adjacent layers undisturbed. In the read out system of the drive, the laser light is filtered out, so that only the information-bearing fluorescent light is detected. This reduces the effect of stray light and interference.

In the above and other data-storage systems (like the conventional reflective optical disc technology), the goal of coding and signal processing is to reduce the BER (Bit error Rate) to a sufficiently low level while achieving such important figures of merit as high density and high data rate. This is accomplished by stressing the physical components of the system well beyond the point at which the channel is error-free, and then introducing modulation coding and signal processing schemes to reduce the BER to levels that can be handled by the Error-Correction (ECC) decoding, and brought further down to very low levels (block error-rate typically 10⁻¹⁶) which are acceptable to users.

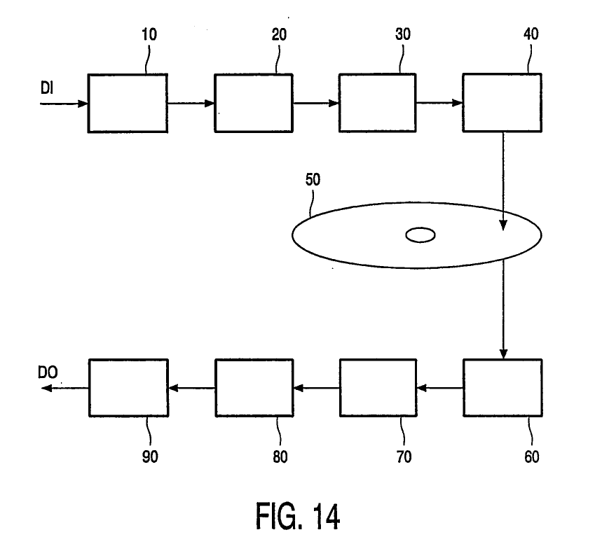

FIG. 14 shows typical coding and signal processing elements of a data storage system. The cycle of user data from input DI to output DO can include interleaving 10, error-correction-code (ECC) and modulation encoding 20, 30, signal preprocessing 40, data storage on the recording medium 50, signal postprocessing 60, binary detection 70, and decoding 80, 90 of the interleaved ECC. The ECC encoder 20 adds redundancy to the data in order to provide protection from various noise sources. The ECC-encoded data are then passed on to a modulation encoder 30 which adapts the data to the channel, i.e. it manipulates the data into a form less likely to be corrupted by channel errors and more easily detected at the channel output. The modulated data are then input to a recording device, e.g. a spatial light modulator or the like, and stored in the recording medium 50. On the retrieving side, the reading device (e.g. charge-coupled device (CCD)) returns pseudo-analog data values which must be transformed back into digital data (typically one bit per pixel). The first step in this process is a post-processing step 60, called equalization, which attempts to undo distortions created in the recording process, still in the pseudo-analog domain. Then the array of pseudo-analog values is converted to an array of binary digital data via a detector 70. The array of digital data is then passed first to the modulation decoder 80, which performs the inverse operation to modulation encoding, and then to an ECC decoder 90.

Interpixel or intersymbol interference (ISI) is a phenomenon in which intensity at one particular pixel contaminates data at nearby pixels. Physically, this arises from the band-limit of the (optical) channel, originating from optical diffraction, or from time-varying aberrations in the lens system, like disk tilt and defocus of the laser beam. An approach to combating such an interference is to forbid certain patterns of high spatial frequency via the modulation coding. A code that forbids a pattern of high spatial frequency (or, more generally, a collection of such patterns of rapidly varying 0 and 1 pixels) is called a low-pass code and can be used for modulation coding/decoding at the modulation encoder 30 and decoder 80. Such modulation codes constrain the information written in a two-dimensional area (like in the allowed pages of a holographic storage) to have limited high spatial frequency content.

Two-dimensional codes with low-pass filtering characteristics are of interest as modulation codes for the above types of novel volumetric optical recording schemes. But two-dimensional (2-D) coding can also be a key issue for new routes that are closer to more conventional types of optical recording, e.g. based upon reflective optical disc technology, using coherent diffraction of two-dimensional patterns (marks) recorded on a two-dimensional area of a card or a disc. In the prior art, coding on square lattices has been considered. In particular, the capacity of checkerboard codes has been studied in W. Weeks, R. E. Blahut, “The Capacity and Coding Gain of Certain Checkerboard Codes”, IEEE Trans. Inform. Theory, Vol. 44, No. 3, 1998, pp 1193-1203. There, various checkerboard constraints have been considered on a square lattice to achieve a low pass characteristic and thus reduce the effects of inter-symbol interference (ISI) during read-out and detection of channel bits.

However, for two-dimensional coding, just as is the case for one-dimensional coding, different coding constraints and coding geometries, other than coding on square lattices as present in the prior art, may lead to more efficient storage, and thus higher storage densities may be achieved. So there is the continuing need to improve the coding efficiency, also in multi-dimensional storage applications.

Moreover, there is a bit-detection problem in 2-D coding, which is typical for coherent signal generation. The reflection signals from a large land portion, i.e. mirror portion at zero-level, and from a large pit portion, i.e. mirror portion below zero-level (at depth λ/4, where λ denotes the wavelength of the radiation used for reading), are completely identical. Thus, the two binary levels cannot be distinguished at detection. In traditional 1-D coding, this problem does not arise because the spot diameter is always larger than the radial width of a pit (or mark) and diffraction always occurs in the radial direction. The reflected light beam therefore looses some intensity by diffraction outside the central aperture. In contrast thereto, the above problem may occur in 2-D coding, since there is no diffraction at all for a focused laser or other radiation spot which is incident on a large pit area or on a large land area. Both behave as ideal mirrors.

It is therefore an object of the present invention to provide an improved two- or more-dimensional coding scheme by means of which error rates due to intersymbol interference and/or large areas of the same (bipolar) bit type can be reduced.

This object is achieved by a method as defined in claim 1, by a system as defined in claim 22, and by a record carrier as defined in claim 32.

According to the invention, a quasi-hexagonal lattice structure is used for multi-dimensional coding. The benefit of such a quasi-hexagonal lattice as compared e.g. to a square lattice results from a subtle combination of coding efficiency and also the effects of the next-nearest neighbors on the inter-symbol interference. With a quasi-hexagonal lattice is meant a lattice that may be ideally hexagonally arranged, but small lattice distortions from the ideal lattice may be present. For instance, the angle between the basic axes of the unit cell may not be exactly equal to 60 degrees. The quasi-hexagonal lattice yields an arrangement of bits that is more resembling the intensity profile of the scanning laser spot used during read-out.

The higher packing density of the hexagonal lattice structure provides a higher code efficiency. Additionally, the constraint regarding the predetermined number of next-nearest bits with the same bit state as the central bit is intended to provide an interference reducing low-pass characteristic of the code spectrum, while the alternative or additional constraint regarding the predetermined number of next-nearest bits with the opposite bit state as the central bit is intended to provide a high-pass characteristic of the code spectrum to prevent large areas of same bit states. Thus, both constraints lead to a reduction in the bit error rate.

Furthermore, another code constraint regarding the next-nearest bits with the same bit state as the central bit can be applied, according to which a predetermined number of azimuthally contiguous bits are set to have the same bit state as the central bit. Thereby, a minimum mark size can be realized to simplify the writing process. This may be beneficial when for instance a laser beam recorder (LBR) is used for the recording of a master disc in a read-only (ROM) application, with the laser beam having not enough resolution to write smaller mark sizes.

Additionally, adapting also the viewing field shape of a read-out objective lens from the usual rectangular to equilateral hexagonal shape will improve the read-out process of such storage mediums.

Other advantageous further developments are defined in the dependent claims.

In the following, a preferred embodiments of the present invention will be described in greater detail with reference to the accompanying drawing figures in which:

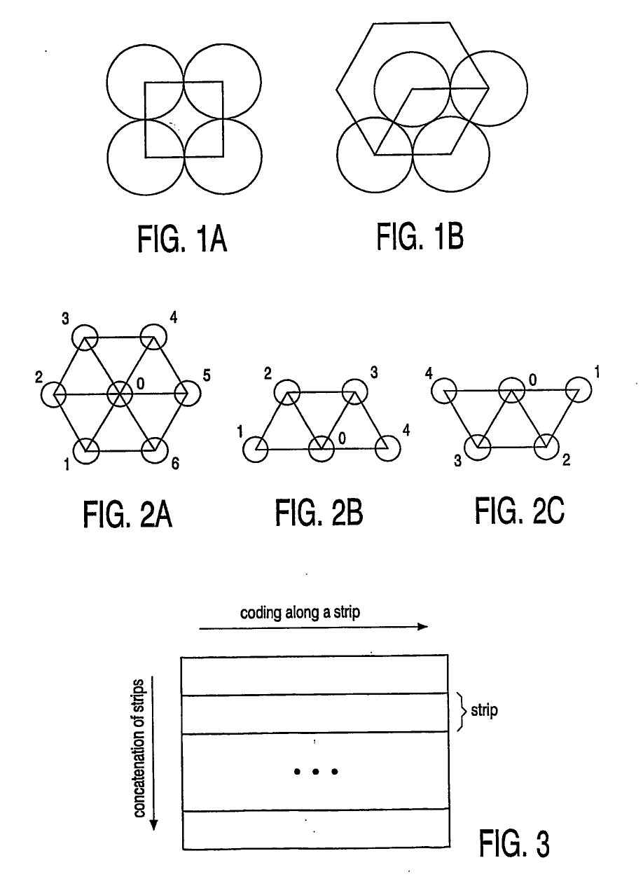

FIGS. 1A and 1B show schematic packing diagrams of a square lattice structure and a hexagonal lattice structure, respectively;

FIGS. 2A to 2C show hexagonal bulk clusters and, bottom and top boundary clusters, respectively, of bit sites according to the preferred embodiments;

FIG. 3 shows a schematic diagram indicating a strip-based two-dimensional coding scheme;

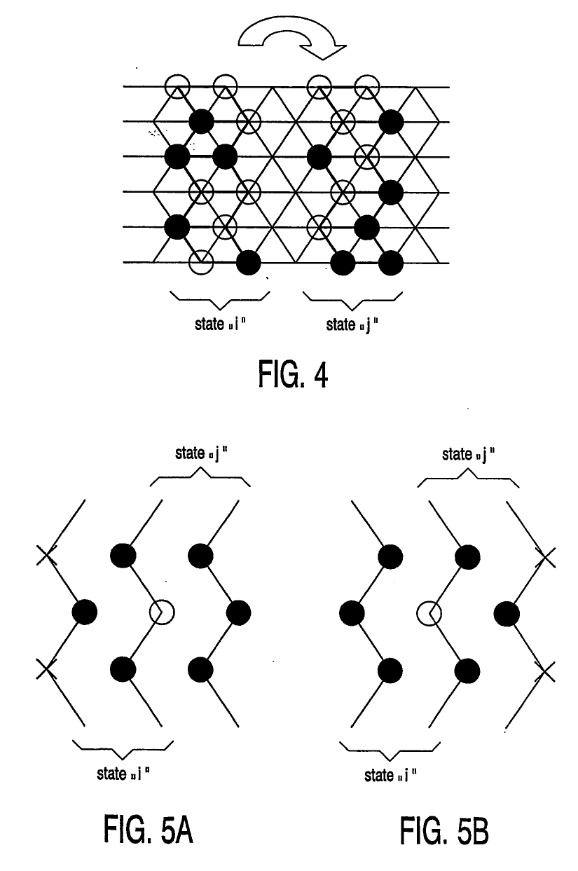

FIG. 4 shows a possible state transition for a two-dimensional coding according to the preferred embodiments;

FIGS. 5A and 5B show forbidden patterns in the bulk area of a strip according to a first preferred embodiment (with Nₙₙ=1);

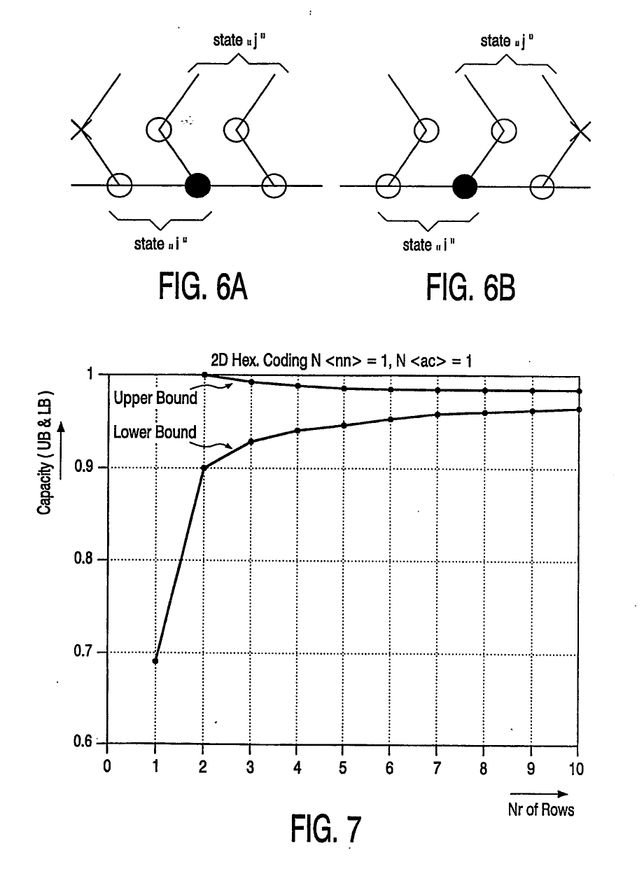

FIGS. 6A and 6B show forbidden patterns in the boundary area of a strip according to the first preferred embodiment (with Nₙₙ=1);

FIG. 7 shows a diagram indicating upper and lower capacity bounds for a first type of hexagonal lattice coding according to the first preferred embodiment;

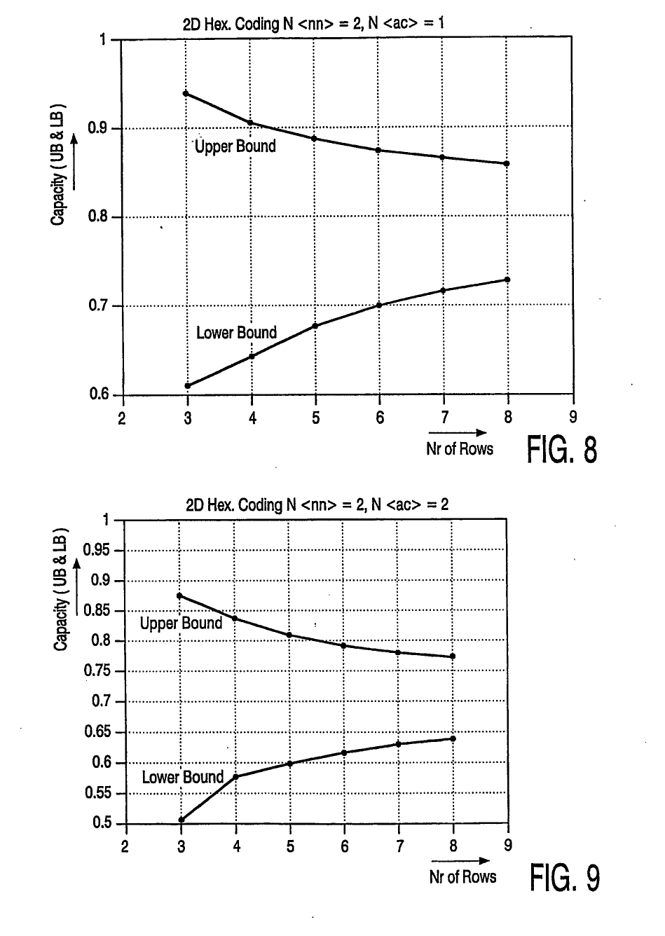

FIG. 8 shows a diagram indicating upper and lower capacity bounds for a second type of hexagonal lattice coding according to the first preferred embodiment;

FIG. 9 shows a diagram indicating upper and lower capacity bounds for a third type of hexagonal lattice coding according to the first preferred embodiment;

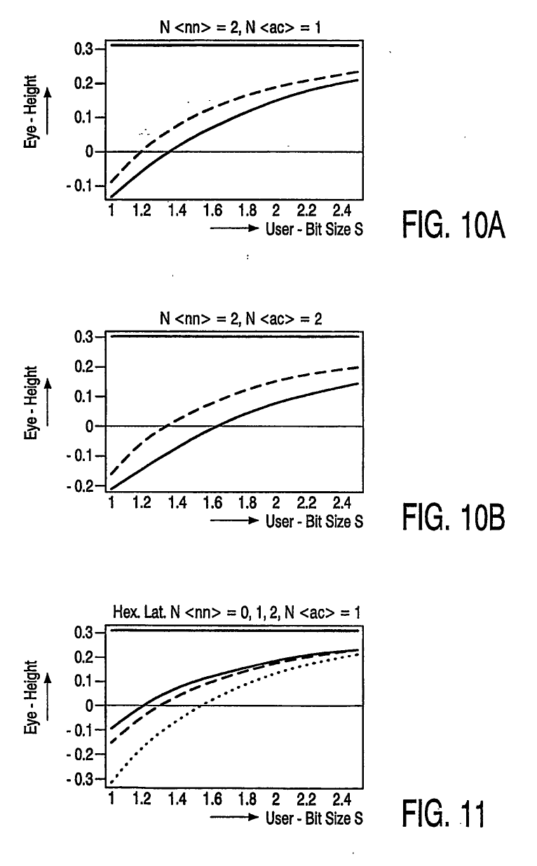

FIGS. 10A and 10B show a diagrams indicating eye-height vs. user-bit size characteristics in square and hexagonal lattice coding at first and second coding constraints, respectively, according to the first preferred embodiment;

FIG. 11 shows a diagram indicating eye-height vs. user-bit size characteristics for hexagonal lattice coding at different code constraints according to the first preferred embodiment;

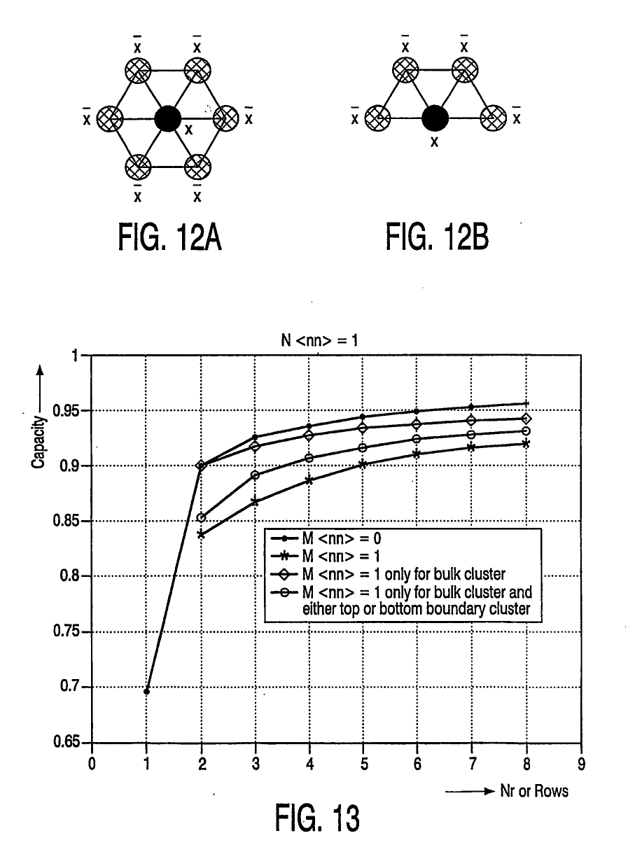

FIGS. 12A and 12B shows forbidden patterns of a bulk cluster and a boundary cluster, respectively, according to a second preferred embodiment;

FIG. 13 shows a diagram indicating a lower capacity bounds for different constraints according to the second preferred embodiment;

FIG. 14 shows a schematic diagram of coding and processing elements of a conventional data storage system; and

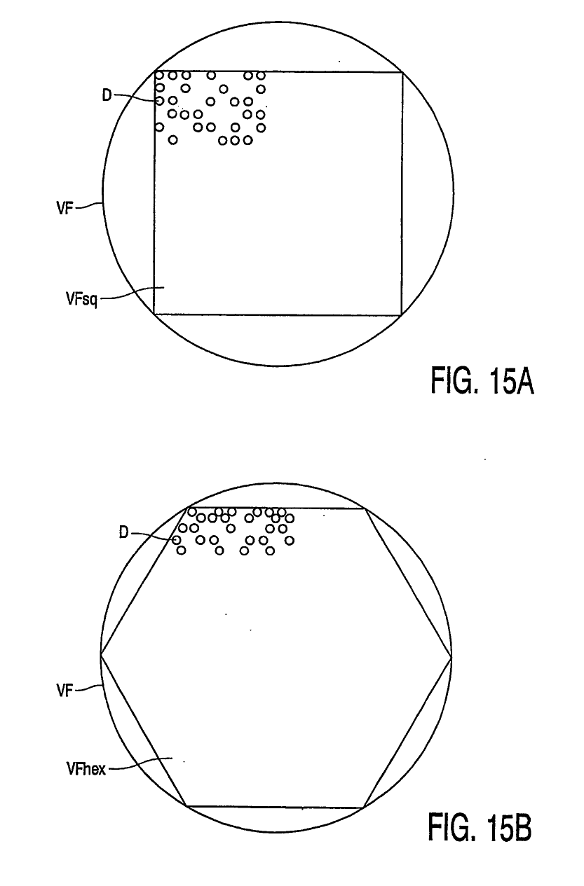

FIG. 15A and 15B show viewing field shapes of pick-up means for the case of a rectangular shape and a equilateral hexagonal shape, respectively.

The preferred embodiments of the present invention will now be described on the basis of strip-based two-dimensional coding scheme in which a quasi-hexagonal lattice is used.

It is known in crystallography that hexagonal lattices provide the highest packing fraction. For instance, its packing fraction is 1/cos (30°)=1.155 better than that of a square lattice with the same distance a between nearest-neighbor lattice points. The latter distance a may be determined by the extent of a two-dimensional impulse response of the two-dimensional channel used for writing to the recording or storing medium 50, e.g. by holographic optical recording or fluorescent optical recording, or by conventional reflective-type of optical recording with coherent diffraction in two-dimensions.

FIGS. 1A and 1B show packaging structures of a square lattice and a hexagonal lattice, respectively. For each lattice point, the square and hexagonal lattices need a two-dimensional area of sizes a² and a² cos(30°), respectively, as shown in FIGS. 1A and 1B, respectively. The number of nearest neighbors is six for a hexagonal lattice, whereas it is four for a square lattice. Therefore, at first glance, the use of a hexagonal lattice does not seem to be advantageous, since the number of nearest neighbors that may lead to two-dimensional inter-symbol interferences is larger. However, the benefit of the hexagonal lattice as compared e.g. to the square lattice results from a combined consideration of the coding efficiency and the effects of the next-nearest neighbors on the inter-symbol interference.

With regard to further neighbors at larger distances, the hexagonal lattice has six next-nearest neighbors at a distance \sqrt{3} (with the nearest neighbor at distance 1), and six next-next-nearest neighbors at distance 2. For the square lattice, four next-nearest neighbors are obtained at a distance \sqrt{2}, and four next-next-nearest neighbors are obtained at a distance 2.

In case of the two-dimensional coding, full-sized hexagonal clusters arranged in the bulk of the hexagonal lattice have seven bit positions or sites, one central site and six nearest-neighboring sites. For reasons of simplicity, the terminology “hexagonal cluster” is used, also when reference is made to a quasi-hexagonal cluster of bits on a quasi-hexagonal lattice. However, at a boundary of a strip of the two-dimensional space, used for the strip-based coding, partial-sized or boundary clusters occur.

FIGS. 2A to 2C show clusters of bit sites on the hexagonal lattice for a bulk cluster, a bottom boundary cluster and a top boundary cluster, respectively. The channel bits xᵢ located at the bits sited are numbered as follows.

In the bulk cluster, the central bit has the number i=0, while the six nearest-neighbor bits are successively numbered i=1 . . . 6 in the order of their azimuth. The incomplete or partial-sized boundary clusters at the edges of a strip consist of only five bits or bit sites, compared to the seven bits or bit sites for the bulk clusters. The central bit also has the number i=0, while the four azimuthally contiguous nearest-neighbor bits are successively numbered i=1 . . . 4.

In the following, new generic code constraints are defined for the hexagonal lattice structure, which relate to the nearest-neighboring sites of the central site of a full- or partial-sized hexagonal cluster.

According to the first embodiment, the constraints have a two-fold aim. Firstly, they are adapted to realize a low-pass characteristic of the code spectrum, and secondly, they are adapted to realize a minimum-mark size which reduces the requirements at the writing channel. In particular, the constraints are described by two parameters:

(i) the minimum number of nearest neighbors (Nₙₙ) of the same type or bit state as the bit located at the central lattice site; and

(ii) the minimum number of azimuthally contiguous nearest neighbors (N_{ac}) with 1≦N_{ac}≦Nₙₙ.

The parameter Nₙₙ provides the low-pass characteristic which is advantageous to reduce the effects of two-dimensional inter-symbol interference. This can easily be seen as follows. Each bit has six nearest neighboring bits. It is assumed that the two-dimensional impulse response function (IRF) has values f0 at the central site, and f1 at the nearest-neighbor sites. Then, the minimum value of the waveform at a given lattice site is realized if there are just Nₙₙ (which is the minimum number) nearest neighbors of the same type. This minimum value is given by:

f0−(6−2Nₙₙ)f1 (1)

The parameter N_{ac} is used in view of minimum-mark size limitations of the write channel. For instance, the constraints Nₙₙ=2, N_{ac}=1 would still allow two nearest neighbors that are not on successive azimuths. Thus, one-dimensional 2T marks (at different azimuths, and with one channel bit in common) are present, and may be difficult to write. However, when Nₙₙ=2, N_{ac}=2, there should be at least two azimuthally contiguous nearest neighbors of the same type, which implies that the one-dimensional 2T marks are forbidden. Instead, the minimum mark is in this case a triangle of bits of the same type. For a two-dimensional write channel, this may be advantageous compared to N_{ac}=1, however, a corresponding rate-loss has to be faced because of the tighter constraint in the latter situation.

The above constraints can be defined as bulk constraints for a full-sized bulk cluster. Then, the two conditions for the bulk constraints are given as follows:

|6x₀+Σᵢ₌₁⁶xᵢ|≧2Nₙₙ (2)

and

∃Jε{0,1, . . . 5}:|x₀+Σᵢ₌₁^{N}^{_{ac}}x_{i+J}|=N_{ac}+1 (3)

Note that the indices of the 6 bits on the border of the quasi-hexagonal cluster are always between the values 1 and 6; whenever the index i+J in relation (3) is outside this range, then i+J is reduced with a multiple of 6 so that it fits within the desired range of 1 to 6. Similarly, the above constraints can be defined as code constraints for a partial-sized boundary cluster. Then, the two conditions for the bulk constraints are given as follows:

|6x₀+Σᵢ₌₁⁴xᵢ|≧2(Nₙₙ+1) (4)

and

∃Jε{0,1, . . . 4−N_{ac}}:|x₀+Σᵢ₌₁^{N}^{_{ac}}x_{i+J}|=N_{ac}+1 (5)

Thus, the cluster constraint are also satisfied at the strip boundaries, irrespective of the actual bits present in the neighboring coding strip. The boundary constraints enable to stack strips on top of each other without any violation of the constraints, since the constraints are to be satisfied already for the incomplete clusters at the boundaries.

FIG. 3 shows a schematic diagram indicating a strip-based two-dimensional coding scheme. The two-dimensional area is divided into strips. A strip is aligned horizontally, and consists of a number Nᵣ of lattice rows. Coding is done in the horizontal direction, and becomes essentially one-dimensional. Code words do not cross boundaries of a strip. The code words may be based on a two-dimensional area consisting of Nᵣ rows and N_{c} columns. The strips are constructed in such a way that concatenation of the strips in the vertical direction does not lead to violations of the above constraints across strip boundaries.

In order to derive the capacity and in order to design efficient codes, the underlying finite state machine (FSM) must be derived, which drives the generation of two-dimensional sequences. Since all constraints that were currently presented relate to nearest neighbors only, it is sufficient to consider states based upon two successive columns on the hexagonal lattice, and covering all rows of the strip. The number of such states is then simply 2^{2Nr}. By transition from a given state towards the next state, a complete column of channel bits is output. By definition, the last column of the first state is identical to the first column of the successor state.

FIG. 4 shows a state “i” (one out of 4096) for the case Nᵣ=6, and one possible or allowable successor state “j”. As can be gathered from FIG. 4, the last column of the state “i” corresponds to the first column of the state “j”. Furthermore, the constraints set out in equations (2) to (4) are all met.

A crucial point in the derivation of the capacity and the design of the two-dimensional channel or modulation codes is the connection matrix D which is a square matrix of size 2^{2N,}×2^{2n,}, with Nst the number of possible states, which is bounded by Nst≦2^{2Nr}. The matrix elements Dij of the connection matrix D are set to “1” in case a state “i” can have the corresponding state “j” as its successor state. All other matrix elements corresponding to non-allowable successor states are set to “0”. Thus, transitions from state “i” to state “j” are allowable if the following conditions are met:

1) The last column of state “i” is identical to the first column of state “j” ;

2) State-transitions may not cause a constraint violation for bulk clusters (bulk constraints). These constraints are the only ones to be considered for the derivation of an upper bound of the capacity.

3) Concatenation of strips may not cause a constraint violation at the boundaries of the strips. Therefore, the boundary constraints are applied so that stacking of strips can be done independent of the content of the neighbouring strips. These constraints are needed for the derivation of a lower bound of the capacity.

FIGS. 5A and 5B show typical examples of forbidden or non-allowed patterns in the bulk area of a strip, for Nₙₙ=1. In this case, the Nₙₙ=1 constraint is violated upon transition from state “i” to state “j”. The parameters “X” indicate don't care positions, which may be set to any bit value. The encoding direction is the right.

FIGS. 6A and 6B show typical examples of forbidden or non-allowed patterns in the boundary area of a strip, for Nₙₙ=1. In this case also, the Nₙₙ=1 constraint is violated for opposite bit states upon transition from state “i” to state “j”.

FIGS. 7 to 9 show various computations of the code capacity for different widths of a strip, i.e. varying number of rows. The upper bound is defined by the capacity with the bulk constraints only, which implies that the strips cannot be concatenated freely. The lower bound is defined for the bulk and boundary constraints, i.e. strips can be freely concatenated, bit this requires an extra overhead which reduces the available capacity.

In case of a single row (Nᵣ=1) of the Nₙₙ=1, N_{ac}=1 case shown in FIG. 7, the case of the lower bound corresponds to a one-dimensional run length limitation (RLL) coding with a d=1 runlength constraint. The minimum run length for d=1 RLL coding (2T) can only be realized in the horizontal direction. The marked increase in (lower bound) capacity upon moving from one to two rows (Nᵣ=2) resides from the fact that the minimum run length constraint (2T) can now also be realized in the oblique directions under angles of 60° and 120° with respect to the horizontal axis of the strip.

FIG. 8 shows the capacity vs. strip width characteristics for the Nₙₙ=2, N_{ac}=1 case, and FIG. 9 shows the capacity vs. strip width characteristics Nₙₙ=2, N_{ac}=2 case. In these cases, the minimum number of nearest neighbors of the same type or state equals two. In the N_{ac}=1 case, the two nearest neighbors of the same type are not necessarily located on successive azimuths. In the N_{ac}=2 case, the two nearest neighbors of the same type are located on successive azimuths. As can be gathered from FIGS. 8 and 9, the higher constraints lead to a lowering of both upper and lower bounds.

FIGS. 10A and 10B show numerically computed diagrams indicating eye-heights vs. user bit size characteristics for the capacities corresponding to the lower bound of FIGS. 8 and 9 for the case of a strip-based coding with a number of rows given by Nᵣ=8. The dashed lines apply to the hexagonal lattice and the solid lines to a conventional square lattice. The impulse response function is assumed to be a two-dimensional Gaussian function (normalized in two dimensions). As a reference, the central tap-value of the two-dimensional IRF is shown in each of FIGS. 10A and 10B as a constant level at the top. It should be noted that practical ranges of interest include positive eye-heights. Thus, the two-dimensional channel is effectively dead for zero eye-height and beyond (similar as the cut-off frequency for a one-dimensional channel). Thus, as expected, the eye-height can be improved by two-dimensional coding upon the hexagonal lattice. A further improvement can be achieved by adding the constraint concerning the azimuthally contiguous nearest neighbors of the same state.

FIG. 11 shows a diagram indicating eye-heights vs. user bit size characteristics for hexagonal-lattice coding only and for Nₙₙ=0,1,2. The coding gain achieved in terms of eye-height is an obvious trend for increasing this constraint. It is achieved by the increasing low-pass nature of the two-dimensional channel code.

The limitations by the write-channel may be characterized by the size of the smallest two-dimensional mark to be written. Clearly, the constraint Nₙₙ=2 and N_{ac}=2 are most interesting in this respect. The shape of the minimum mark is different for hexagonal-lattice and square-lattice coding. In both cases, the minimum shape is a triangle of 3 channel bits. In the former case, the shape is a regular triangle with equal sides and corners, in the latter case, the shape is less favourable in view of writing, since it is a triangle obtained as half of a square. The relative size of the minimum mark for the same constraints of depends on the ratio of the respective capacities for hexagonal-lattice and square-lattice coding. For Nₙₙ=2 and N_{ac}=2, this ratio equals 1.60, which is in favour of the hexagonal lattice.

In traditional one-dimensional RLL coding, the spot diameter of the radiation beam of the reading system is always larger than the radial width of a pit region of an optical recording or storage medium. Therefore, diffraction is obtained in the radial direction, which causes a detectable loss in the intensity of the reflected beam. However, in the above described two-dimensional coding according to the first preferred embodiment, large pit areas, consisting of a number of neighboring bits, may occur. Then, no diffraction occurs in the large pit region and no intensity loss can be detected.

According to the second preferred embodiment, large areas of channel bits of the same type are avoided by an additional or alternative constraint of the two-dimensional channel or modulation code. This constraint can be realized by a single parameter leading to high-pass characteristics of the two-dimensional code.

In particular, a high-pass constraint is introduced by the parameter Mₙₙ, which indicates the minimum number of nearest neighbors that must be of the opposite bit type or bit state compared to the bit value of the channel bit at the central site of a hexagonal cluster.

For the bulk cluster, the above high-pass constraint parameter Mₙₙ can be combined with the low-pass constraint parameter Nₙₙ in a single relation, given by:

2Nₙₙ≦|6x₀+Σⱼ₌₁⁶xⱼ|≧12−2Mₙₙ (6)

For the boundary cluster, the two constraint parameters Mₙₙ and Nₙₙ lead to two relations given by:

2Nₙₙ≦|4x₀+Σⱼ₌₁⁴xⱼ| (7)

and

|8x₀+Σⱼ₌₁⁴xⱼ|≦12−2Mₙₙ (b 8)

FIGS. 12A and 12B show examples of a forbidden pattern of a bulk cluster and a bottom boundary cluster, respectively, for the situation where at least one of the nearest-neighbor bits should be of the opposite type or state (Mₙₙ=1). The bit at the central lattice site has a value x (i.e. “0” or “1”), and all surrounding bits have the same value. Thus, the above high-pass constraint is not satisfied.

As regards the coding capacity, an additional capacity loss has to be faced by the extra high-pass constraint. For the constraints Nₙₙ=1, Mₙₙ=1, this capacity loss is such that for a strip of three rows, a code with a mapping 8-to-9 is impossible, whereas this mapping was possible for the case Nₙₙ=1, Mₙₙ=0.

For two-dimensional strips with a small number of rows per strip, the high-pass constraint turns out to be quite capacity consuming when applied both to bulk clusters and to boundary clusters. Therefore, it may be advantageous to choose different constraint combinations for bulk clusters and boundary clusters. On one hand, the high-pass constraint may only be used for bulk clusters, while on the other hand, the high-pass constraint may by used for bulk clusters and either the top or the bottom boundary cluster.

FIG. 13 shows a diagram indicating capacity vs. strip width characteristics for the constraints Nₙₙ=1 for bulk and boundary clusters, and Mₙₙ=1 for different situations, i.e. for none of the clusters, for bulk clusters only, for bulk clusters and only top or bottom boundary clusters, and for bulk clusters and for both types of boundary clusters (in the order of appearance of the curves in the diagram from top to bottom). It can be gathered from FIG. 13 that an increased application of the high-pass constraint leads to a reduced code capacity.

The actual code construction combining the Nₙₙ an the Mₙₙ constraints leads to an increased complexity in the code design. As practical codes, it is possible to generate a code with 8-to-9 mapping for a three-row based strip with constraints Nₙₙ=1 for bulk and both boundaries, and Mₙₙ=1 for bulk and only one boundary. Furthermore, it is possible to generate a code with a 11-to-12 mapping for a three-row based strip with constraints Nₙₙ=1 for bulk and both boundaries, and Mₙₙ=1 only for bulk and not for any of the boundaries.

In the above preferred embodiments, identical constraints have been considered for both bit states or types, e.g. marks and non-marks or pits and lands. However, depending on the characteristics of the write-channel, it could be advantageous to impose asymmetric constraints, i.e. different constraints for the two types or states of bits. Also for the case of the boundary cluster at the boundary not of a single strip, but at the boundary of a 2D area, bounded by some guard band, it may be efficient to have less constrained coding on land-bits than on pit-bits, because the guard area comprises a larger land area anyhow. Furthermore, the horizontal direction selected for the two-dimensional strip may be the [100]-direction or the [110]-direction of the hexagonal lattice.

When ordering domains, which are areas on a recording medium carrying stored information as for instance pits or marks, in at least two dimensions (2D recording), it has been shown above that using a quasi-close-packed lattice as in a hexagonal-lattice the highest possible area storage density can be achieved. Moreover, this can also be used for enhancing read-out of such recorded data, especially concerning the arrangement of pick-up means, which can be a read-out optics comprising a objective lens for imaging the stored data onto a image plane, wherein within the image plane detector means are arranged for detecting the read-out data. The circular viewing field VF of the objective lens is not used efficiently due to the fact that only a fraction of the circular image plane is used by the detector means. Therefore, FIG. 15A shows the arrangement of the read-out objective lens for 2D read-out, especially the circular shaped viewing field VF defining the image plane, when ordering the domains D in squared lattice according to a rectangular coordinate system. Within the viewing field VF a square shaped area is shown corresponding to a square shaped viewing field VFsq of the detector means defined by the arrangement of detector elements in the image plane.

As can be derived from FIG. 15A besides the lower area storage density, there is only used a fraction of 2/π, round about 64%, of the circular shaped viewing field VF of the objective lens by the square shaped viewing field VFsq of the detector means. However, if the data domains D are arranged in the herein introduced quasi-hexagonal lattice structure, the data storage density will be increased, but due to the mismatch between the square shaped viewing field VFsq of the detector means and the quasi-hexagonal-lattice of the data domains no seamlessly read-out will be possible. This causes a difficult read-out and results in a lower read-out rate.

Therefore, in FIG. 15B a hexagonal shaped viewing field VFhex of the detector means within the circular shaped viewing field VF of the objective lens, which in this embodiment is a equilateral hexagon, is introduced. This leads to a higher data storage density, an increase of round about 15% as compared to the square lattice, and additionally to a higher read-out rate due to more efficiency in the use of the viewing field VF of the objective lens. In particular, a fraction of 3 cos 30°/π, round about 83%, of the viewing field VF can be used. That is an increase of nearly 30% and a total improvement of nearly 50% taking both effects, the quasi-hexagonal lattice arrangement of the data domains and the hexagonal shaped viewing field VFhex of the detector means, together. Moreover, a possibility is provided to obtain a seamlessly stitching of these equilateral hexagon shaped viewing field VFhex during read-out.

It should be noted that the maximum data rate during read-out is achieved only when read-out is performed along one of the three possible directions defined by the [100], [010] or [110] lattice-directions of the quasi-hexagonal lattice structure. In these cases, the maximum spatial frequency is given when one lattice plane (of the type (100), (010), or (110)) filled with only “pit”-domains (or pit-bits) is alternated with one lattice plane filled with only “land” domains (or land-bits). This highest spatial frequency, of course, must be lower than the cut-off frequency of the read-out optics of the pick-up means.

The most obvious way to perform the reproduction of the 2D data structure within the viewing field of the detector means is by a coherent illumination of the appropriate area on the recording medium containing the data domains. By choice, these areas can be scanned continuously or in a stepped manner. In the first case, data domains in the image plane of the disk are moving across the read-out detector array and thus, the data of one particular domain has to be collected by different detector segments at different time-steps in order to obtain sufficient light energy from this particular domain. In the second case, data domains are stationary with respect to the detector array for a certain time, in which the data signals in the viewing field can be added or integrated, respectively. After reading-out the data domains of a particular viewing field the pick-up means have to be moved to an adjacent field, and so on.

Except for fluorescent read-out, however, coherent illumination has a cut-off frequency, which is half of that of an incoherent illumination. With incoherent illumination, an array of individual spots, which can be produced by a grating in the illuminating part of the pick-up means, is scanned along one edge of the hexagonal structure. It should be noted that adjacent spots may not overlap. Therefore, the track pitch will be much smaller than the distance between successive spots. In order to read-out adjacent tracks at the same time, the spots are positioned obliquely with respect to the tracks. The illuminating spots within the viewing field of the objective lens of the pick-up means may be distributed in various ways, however, the largest density is obtained with an distribution on a quasi-hexagonal lattice.

It is noted, that the described hexagonal-lattice based multi-dimensional coding can be used in any data storage system, such as a two-dimensional optical storage in which holographic optical recording, fluorescent optical recording, page-oriented optical recording, conventional reflective type of optical storage but coded in two dimensions, or the like is applied, or any other kind of storage system where high and/or low-pass code characteristics are desirable. Particularly, the invention is also intended to cover record carriers, e.g. optical disks, used in such data storage systems, on which an information is written or stored by using the described multi-dimensional coding scheme. Furthermore, the described coding scheme can be applied for any multi-dimensional coding in more than two dimensions. For instance, in three dimensions, use can be made of quasi-close-packed lattice structures. In three dimensions, such close-packed lattice structures may be a face-centered cubic lattice, also known as FCC lattice, or it may be a hexagonally close-packed lattice, also known as the HCP lattice. The invention is thus intended to cover any modification within the scope of the attached claims.

1. A method for multi-dimensionally coding and/or decoding an information to/from a lattice structure representing bit positions of said coded information in at least two dimensions, said method comprising the step of using a quasi-close-packed lattice structure for said multi-dimensional coding and/or decoding.

2. A method according to claim 1, wherein said quasi-close-packed lattice structure is based on a quasi-hexagonal lattice.

3. A method according to claim 2, wherein said method further comprises the steps of:
a) defining at least partial quasi-hexagonal clusters consisting of one central bit and a plurality of nearest neighboring bits; and
b) applying a first code constraint such that for each of said at least partial quasi-hexagonal clusters a predetermined minimum number of said nearest neighboring bits are of the same bit state as said central bit.

4. A method according to claim 3, wherein said predetermined minimum number of said nearest neighboring bits is less or equal than three.

5. A method according to claim 2, further comprising the steps of:
a) defining at least partial quasi-hexagonal clusters consisting of one central bit and a plurality of nearest neighboring bits; and
b) applying a first code constraint such that for each of said at least partial quasi-hexagonal clusters a predetermined minimum number of said nearest neighboring bits are of the opposite bit state as said central bit.

6. A method according to claim 5, wherein said predetermined minimum number of nearest neighboring bits is one.

7. A method according to claim 3, wherein said coding and/or decoding is a strip-based two-dimensional coding and/or decoding, and said at least partial quasi-hexagonal clusters comprise a bulk cluster having six nearest neighboring bits and a boundary cluster having four nearest neighboring bits and being located at an edge of a coding strip along which said coding and/or decoding is performed.

8. A method according to any one of claim 7, wherein said coding strip is oriented in the [100] or [110] direction of said quasi-hexagonal lattice structure.

9. A method according to claim 1, wherein a viewing field of a pick-up means has a hexagonal shape.

10. A method according to claim 9, wherein said hexagonal shape is an equilateral hexagonal shape.

11. A method according to claim 9, wherein read-out of stored data is performed by using detector means arranged to produce signals corresponding to said stored data, in an image plane of said pick-up means.

12. A method according to claims 11, wherein said read-out is performed with a continuous movement of said pick-up means over said lattice structure containing said stored data.

13. A method according to claim 12, wherein said stored data is detected by collecting the detector signals of different segments of said detector means at different time steps.

14. A method according to claim 9, wherein read-out is performed with a stepped movement of said pick-up means over said lattice structure containing stored data.

15. A method to claim 14, wherein said stored data is detected by summation of signals of individual detector segments for a certain time.

16. A method according to claim 12, wherein said movement of said pick-up means is performed along the [100] or [110] direction of said quasi-hexagonal lattice structure containing said stored data.

17. A system for multi-dimensionally coding and/or decoding an information to and/or from a lattice structure representing bit positions of said coded information in at least two dimensions, said apparatus comprising encoding means (30) and/or decoding means (80), arranged to perform encoding and/or decoding, respectively, by using a quasi-hexagonal lattice structure, to define at least partial quasi-hexagonal clusters consisting of one central bit and a plurality of nearest neighboring bits, and to apply a code constraint such that for each of said at least partial quasi-hexagonal clusters a predetermined minimum number of said nearest neighboring bits are of the same bit state as said central bit.

18. A system for multi-dimensionally coding and/or decoding an information to/from a lattice structure representing bit positions of said coded information in at least two dimensions, said apparatus comprising encoding means (30) and/or decoding means (80), arranged to perform encoding and/or decoding, respectively, by using a quasi-hexagonal lattice structure, to define at least partial quasi-hexagonal clusters consisting of one central bit and a plurality of nearest neighboring bits, and to apply a code constraint such that for each of said at least partial quasi-hexagonal clusters a predetermined minimum number of said nearest neighboring bits are of the opposite bit state as said central bit.

19. A system according to claim 17, wherein said system is a data storage system.

20. A system according to claim 17, wherein the shape of the viewing field of a pick-up means is a hexagonal shape.

21. A system according to claim 20, wherein said hexagonal shape is an equilateral hexagonal shape.

22. A system according to claim 17, wherein read-out of stored data is performed by a detector plane in an image plane of said pick-up means.

23. A system according to claim 17, wherein said read-out is performed with a continuous movement of said pick-up means over the storage medium.

24. A system according to claim 23, wherein the stored a is read-out by collecting the detected signals of different detector segments at different time steps.

25. A system according to claim 17, wherein the read-out is performed with a stepped movement of said pick-up means.

26. A system to claim 25, wherein the stored data is read-out by summation the signals of individual detector segments for a certain time.
